(19) United States
(12) Patent Application Publication
(10) Pub. No.: US 2017/0009505 A1
(43) Pub. Date: Jan. 12, 2017

(54) Hidden Hinge System

(71) Applicant: Barnes Group Inc., Bristol, CT (US)

(72) Inventors: Jack Adoline, Holland, OH (US); Thomas Fischer, Bristol, CT (US); David Johnson, Bristol, CT (US); Joel McCoy, Bristol, CT (US)

(73) Assignee: BARNES GROUP INC.

(21) Appl. No.: 15/196,104

(22) Filed: Jun. 29, 2016

Related U.S. Application Data
(60) Provisional application No. 62/190,465, filed on Jul. 9, 2015.

(51) Int. Cl. E05F 1/12; E05D 3/02; E05D 13/00; E05D 11/04

(52) U.S. Cl. CPC E05F 1/12; E05D 11/04; E05D 3/022; E05F 1/1292; E05D 13/12; E05F 1/1207

(57) ABSTRACT

A spring system that translates linear motion into rotary motion near or on the hinge line of a hinge assembly.

The present invention claims priority to U.S. Provisional Application Ser. No. 62/190,465, filed on Jul. 9, 2015, which is fully incorporated herein.

The present invention relates to spring systems, particularly to a spring system that translates linear motion into rotary motion, and more particularly to a spring system that translates linear motion into rotary motion at, near, or on the hinge line of a counterbalanced device.

### BACKGROUND OF THE INVENTION

Containers that include hinged lids such as storage containers typically must be manually opened. Some of these containers include springs for use as a counterbalance to facilitate in the opening and closing of the lid. However, these counterbalance springs cannot control the opening and closing of the lid. Motorized mechanisms are available to open and close a container lid; however, these devices are bulky and are generally difficult to install.

In view of the prior art, there remains a need for a lid opening device that is easy to use and install, and which conveniently fits within a container.

### SUMMARY OF THE INVENTION

The present invention is directed to a novel spring system that includes the use of a linear motion device that produces linear motion and a rotary motion translation device that translates such linear motion into rotary motion. The present invention can be configured to translate linear motion into rotary motion at, near, or on the hinge line of a door, lid, etc. which may or may not be counterbalanced. The concept being described takes the force of a linear motion device, such as a mechanical spring (e.g., m-Struts®, etc.), a gas spring, urethane spring, hydraulic piston, electromechanical spring, etc. and translates such force into rotary motion. The present invention can be used with a hinge to cause the hinge to rotate and thereby cause a door, lid, etc. to open and/or close.

In one non-limiting aspect of the present invention, the linear motion device may be, but is not limited to, mechanical springs and/or gas springs.

In another and/or alternative non-limiting aspect of the present invention, the linear motion device can include a rod that does not rotate or rotates less than 360° about the longitudinal axis of the rod. In one non-limiting configuration, the rod has a non-circular cross-sectional shape partially or fully along the longitudinal length of the rod that can be used to inhibit or prevent the rod from rotating as the rod moves between the fully extended and fully retracted positions. In another non-limiting configuration, the rod includes one or more grooves, ribs, or other surface structures that can be used to inhibit or prevent the rod from rotating as the rod moves between the fully extended and fully retracted positions.

In another and/or alternative non-limiting aspect of the present invention, the rotary motion translation device that is configured to engage the rod to cause a hinge to rotate can be used in a variety of applications such as, but not limited to, boat compartments, small hatches, doors, blinds, shutters, or any application where controlled rotational movement is required. A counter-balance can optionally be used with the linear motion device and the rotary motion translation device to facilitate in the operation of the novel spring system in a particular application.

Non-limiting advantages and features of the present invention are 1) can optionally be used as a counterbalance, 2) can optionally be used with a counterbalance, 3) compact configuration, 4) can utilize a variety of different linear motion devices (gas spring system, mechanical spring system, gas and mechanical spring system, hydraulic piston system, electromechanical spring system, urethane spring system, etc.), 5) can be used with different rotary motion translation devices, and/or 6) can optionally have a modular configuration.

A non-limiting overview of the rotary motion system of the present invention is as follows:

1) The linear motion device may be, but is not limited to a) a gas spring to provide linear motion; b) a mechanical spring to provide linear motion; c) a urethane spring to provide linear motion; d) an electromagnetic piston arrangement to provide linear motion; and/or d) a hydraulic piston arrangement to provide linear motion.

2) The rotary motion translation device can include, but is not limited to: a) a device which is caused to rotate as the rod moves through the device. This type of rotary motion device can include, but is not limited to a) a “Yankee” screwdriver or Archimedes Drill configured device; b) a ball screw with a device which translates the linear force into rotation; c) an acme threaded rod with a device which translates the linear force into rotation; and/or d) ball reverser with a device which translates the linear force into rotation.

The spring system can optionally include a housing arrangement that houses the linear motion device and the rotary motion translation device, but also serves to attach the rotary motion system to a door, compartment or other type of application that is to be used with the rotary motion system. The housing arrangement can be configured to enable the linear motion device to be interchangeable and replaceable; however, this is not required. The rotary motion system can be secured to a door, compartment or other type of application that is to be used with the rotary motion system by any number of means (e.g., adhesive, weld bead, melted seam, rivets, screws, clamps, bolts, threaded ends, etc.).

Non-limiting applications for the spring system of the present invention include, but are not limited to:

a) marine applications wherein lift force on hatches or storage devices is required, but obstructions are undesirable;

b) ground hatches where counterbalancing is desirable, but space is at a premium and the intrusion of a conventional counterbalance solution is undesirable;

c) storage units where counterbalancing is desirable, but space is at a premium and the intrusion of a conventional counterbalance solution impedes the storage devices usefulness;

d) vehicle hoods and compartments where obstructions would impede access or maintenance;

e) devices that uses a hinge for opening and closing, and/or for moving a locking arrangement between a locked and unlocked position;

f) arrangements that require a compact system for moving a hinge for opening and closing, and/or for moving a locking arrangement between a locked and unlocked position; and/or,

g) arrangements that require counterbalancing for moving a hinge for opening and closing, and/or for moving a locking arrangement between a locked and unlocked position.

In one non-limiting aspect of the present invention, the linear motion device can be in the form of a strut; however, this is not required. The strut can include a housing body having an internal cavity. The internal cavity can have a generally uniform cross-sectional shape and a generally constant cross-sectional area along the longitudinal length of the housing body; however, this is not required. The materials used to form the housing body are non-limiting. The size, shape and length of the housing body are non-limiting. The rear portion of the housing body typically includes a plug; however, this is not required. The plug can be configured to be removable; however, this is not required. Indents in the housing body or other arrangements (e.g., adhesive, rivet, screw, pin, solder, weld bead, melted bond, etc.) can be used to secure the plug to the housing; however, this is not required. The rear end of the strut can optionally include a connection arrangement that can be used to facilitate in connecting the rear of the strut to a fixture or other structure. The configuration of the connection arrangement is non-limiting (e.g., threaded end, connection hole, grooves, ribs, slots, notches, hook, etc.).

In another and/or alternative non-limiting aspect of the present invention, one or both ends of the housing can optionally include a bushing. The bushing located at the front portion of the housing body generally includes an opening through the longitudinal length of the bushing to enable a rod to move through the bushing along the longitudinal axis of the housing body. In one non-limiting configuration, the rod is configured to only extend outwardly from the front end of the housing body; however, this is not required. In such a configuration, the strut will typically only include a bushing at the front portion of the housing body. The bushing can be configured to be removable or irremovable from the housing body. Front and/or rear flanges can be used to facilitate in securing the bushing at the front portion of the housing body; however, this is not required. As can be appreciated, other and/or alternative means can be used to secure the bushing to the housing (e.g., adhesive, rivet, screw, nail, pin, solder, weld bead, melted bond, ribs, grooves, indents, notches, etc.). The bushing can be formed from a variety of materials (e.g., plastic, polymer material, rubber, metal, composite material, wood, etc.). The bushing can be configured to partially or fully encircle a portion of the rod.

In another and/or alternative non-limiting aspect of the present invention, the rod extends outwardly from the front end of the housing body through the opening in the bushing and is configured to move along a longitudinal axis of the housing body. The rod can be positioned along the central longitudinal axis of the housing body; however, this is not required. The length, shape, configuration and material of the rod are non-limiting. The housing body generally has a tubular shape and the cross-sectional shape of the rod and housing body are generally circular; however, this is not required. The cross-sectional area of the portion of the rod that moves within the cavity of the housing body is generally less than the cross-sectional area of the cavity of the housing body; however, this is not required. The front end of the rod generally includes an arrangement that is used to interact with the rotary motion translation device. The front end of the rod generally includes one or more surface features configured to partially or fully interact with a corresponding feature of the linear to rotary motion translation device; however, this is not required. Non-limiting surface features include grooves, ribs, threads and the like. The one or more surface features can be formed on a portion of the rod that can be connected to and/or disconnected from another portion of the rod, or can be formed on a single-pieced rod.

In another and/or alternative non-limiting aspect of the present invention, the rod and housing of the linear motion device includes a rotation limit arrangement that inhibits or prevents the rod from rotating 360° about the longitudinal axis of the rod as the rod moves between the fully extended and fully retracted positions. Generally, the rotation limit arrangement is configured to inhibit or prevent the rod from rotating any more than 30° about the longitudinal axis of the rod as the rod moves between the fully extended and fully retracted positions. In another non-limiting embodiment, the rotation limit arrangement is configured to inhibit or prevent the rod from rotating any more than 10° about the longitudinal axis of the rod as the rod moves between the fully extended and fully retracted positions. In still another non-limiting embodiment, the rotation limit arrangement is configured to limits the rod to rotating about 0°-5° about the longitudinal axis of the rod as the rod moves between the fully extended and fully retracted positions. In one non-limiting embodiment, the rod and housing of the linear motion device includes a rotation limit arrangement that inhibits or prevents the rod from rotating. In another and/or alternative non-limiting arrangement of the present invention, the rod includes a surface structure and/or cross-sectional shape that is configured to interact with another structure of the linear motion device to thereby inhibit or prevent the rod from rotating about the longitudinal axis of the rod as the rod moves between the fully extended and fully retracted positions. In another and/or alternative non-limiting arrangement of the present invention, the rod includes a surface structure and/or cross-sectional shape that is configured to interact with another structure of the spring system (e.g., mount block, bushing, etc.) to thereby inhibit or prevent the rod from rotating about the longitudinal axis of the rod as the rod moves between the fully extended and fully retracted positions. Non-limiting structures on the rod include, but are not limited to, a groove, a rib. For example, the rod can includes a groove along at least a portion of the longitudinal length of the rod that is configured to interact with a pin, rib, etc. on the bushing, housing, etc. of the linear motion device, thereby inhibiting or preventing the rod to rotate relative to the housing of the linear motion device as the rod moves between the fully extended and fully retracted positions. Non-limiting cross-sectional shapes that can be used to inhibit or prevent the rod from rotating about the longitudinal axis of the rod as the rod moves between the fully extended and fully retracted positions are non-circular cross-sectional shapes such as, but not limited to, oval, square, triangular, rectangular, polygonal, etc.

In another and/or alternative non-limiting aspect of the present invention, a portion of the rod that moves within the cavity of the housing body can include a piston connected thereto; however, this is not required. Generally, the piston can be connected to the rear end or rear portion of the rod; however, this is not required. The piston can be connected to the rod by any number of means (e.g., adhesive, screw, rivet, nail, pin, solder, weld bead, melted bond, etc.).

In another and/or alternative non-limiting aspect of the present invention, one or more mechanical springs are optionally located in the cavity of the housing body. The one or more mechanical springs (when used) can be located on one or both sides of the piston. When two or more mechanical springs are located in the internal cavity of the housing body, the spring free length, wire type, wire thickness, cross-sectional shape of the wire, number of windings, wire material, and/or spring force of each spring can be the same or different. The free length of one or more mechanical springs can be greater than, equal to, or less than the longitudinal length of the cavity of the housing body. As can be appreciated, when two or more springs are located on the same side of the piston, two or more of the springs can optionally be in a nested relationship and have the same or different direction of windings. As can be appreciated, a fluid (e.g., gas and/or liquid) optionally can be located on one or both sides of the piston. The fluid can be used in combination with one or more springs or as a substitute for one or more springs in the strut. When fluid is included in the internal cavity of the housing body, the piston can be configured to controllably allow the fluid to flow through or past the piston as the piston moves along the longitudinal length of the housing; however, this is not required.

In operation, the rotary motion translation device is configured to rotatably interact with the rod as the rod reciprocates in the housing body of the linear motion device. Generally, the rod includes grooves, slots, notches, ribs, and/or other types of structures that are configured to engage with structures in the rotary motion translation device to cause at least a portion of the rotary motion translation device to rotate as a portion of the rod or a structure connected to the rod moves in a linear direction on or through a portion of the rotary motion translation device. In one non-limiting configuration of the present invention, the rotary motion translation device includes an opening wherein a portion of the rod or a structure connected to the rod moves through the opening. As the portion of the rod or the structure connected to the rod moves through the opening, a portion of the rotary motion translation device is caused to rotate. In one non-limiting arrangement, the rotary motion translation device is integrated in a hinge. In such an arrangement, a portion of the hinge is caused to rotate between an open and closed position as the portion of the rod or structure connected to the rod moves forward and backward through the opening. As can be appreciated, the rotary motion translation device can be configured to be stationary as the rod moves through the opening in a portion of the rotary motion translation device, thereby causing the linear motion device to rotate as the portion of the rod or structure connected to the rod moves forward and backward through the opening in the rotary motion translation device; however, this is not required.

It is accordingly one non-limiting object of the present invention to provide a novel spring system that translates linear motion into rotary motion.

It is another non-limiting object of the present invention to provide a novel spring system that translates linear motion into rotary motion and can be used with a hinge assembly.

It is another and/or alternative non-limiting object of the present invention to provide a novel spring system which is capable of translating linear motion into rotary motion at, near, or on the hinge line of a counterbalanced device.

It is another and/or alternative non-limiting object of the present invention to provide a novel spring system that includes a linear motion device and a rotary motion translation device.

It is another and/or alternative non-limiting object of the present invention to provide a novel spring system that includes a linear motion device that includes a rod that does not rotate or rotates less than 360° about the longitudinal axis of the rod as the rod moves between the fully extended and fully retracted positions.

It is another and/or alternative non-limiting object of the present invention to provide a novel spring system that includes a linear motion device having a rod that has a non-circular cross-sectional shape partially or fully along the longitudinal length of the rod.

It is another and/or alternative non-limiting object of the present invention to provide a novel spring system that includes a linear motion device that has a rod with one or more surface structures used to inhibit or prevent the rod from rotating as the rod moves between the fully extended and fully retracted positions.

These and other objects and advantages will become apparent from the discussion of the distinction between the invention and the prior art and when considering the non-limiting embodiments of the invention as shown in the accompanying drawings.

### BRIEF DESCRIPTION OF THE DRAWINGS

Reference may now be made to the drawings, which illustrate various embodiments that the invention may take in physical form and in certain parts and arrangements of parts wherein:

FIG. 1 is a cross-sectional illustration of a spring system in accordance with the present invention incorporated into a hinge assembly, wherein the hinge is in a closed position;

FIG. 2 is a cross-sectional illustration of the spring system of FIG. 1, wherein the hinge is in an open position.

FIG. 3 is a cross-sectional illustration of the spring system of FIG. 1 taken along line 3-3 in FIG. 1;

FIG. 4 is a cross-sectional illustration of the spring system of FIG. 2 taken along line 4-4 in FIG. 2;

FIG. 5 is a partial perspective illustration of a rotary motion translation device according to one non-limiting embodiment of the present invention;

FIG. 6 is a perspective illustration of another rotary motion translation device according to another non-limiting embodiment of the present invention; and,

FIG. 7 is a perspective illustration of another rotary motion translation device according to another non-limiting embodiment of the present invention.

### DETAILED DESCRIPTION OF NON-LIMITING EMBODIMENTS

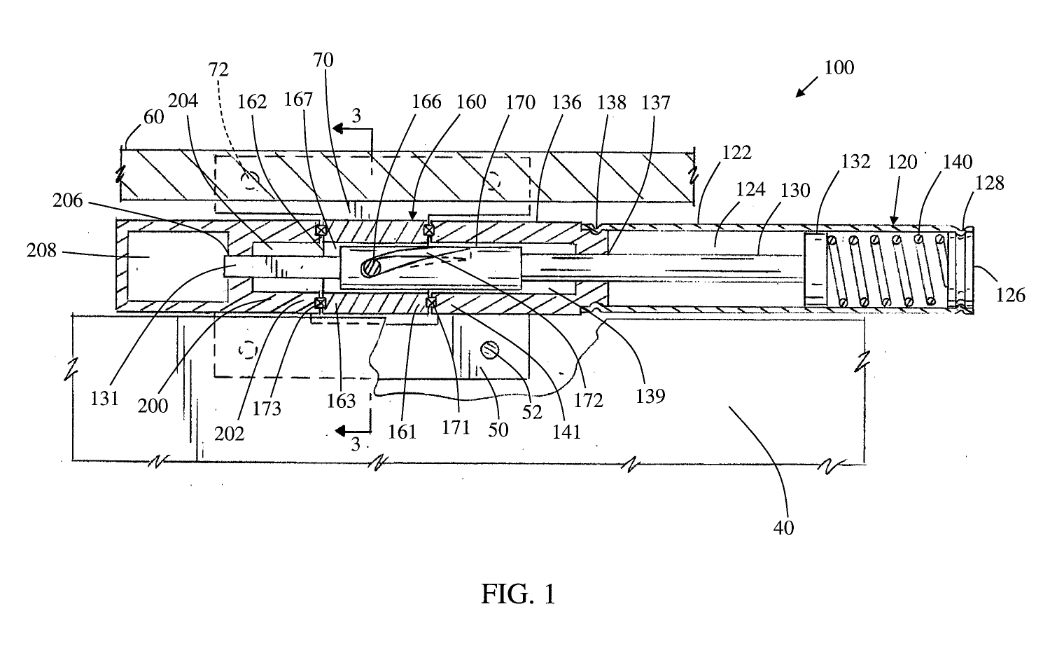

Referring now to the drawings, wherein the showings are for the purpose of illustrating at least one non-limiting embodiment of the present invention only and not for the purpose of limiting the same, FIGS. 1-7 illustrate various non-limiting embodiments of an improved spring system in accordance with the present invention that translates linear motion to rotary motion.

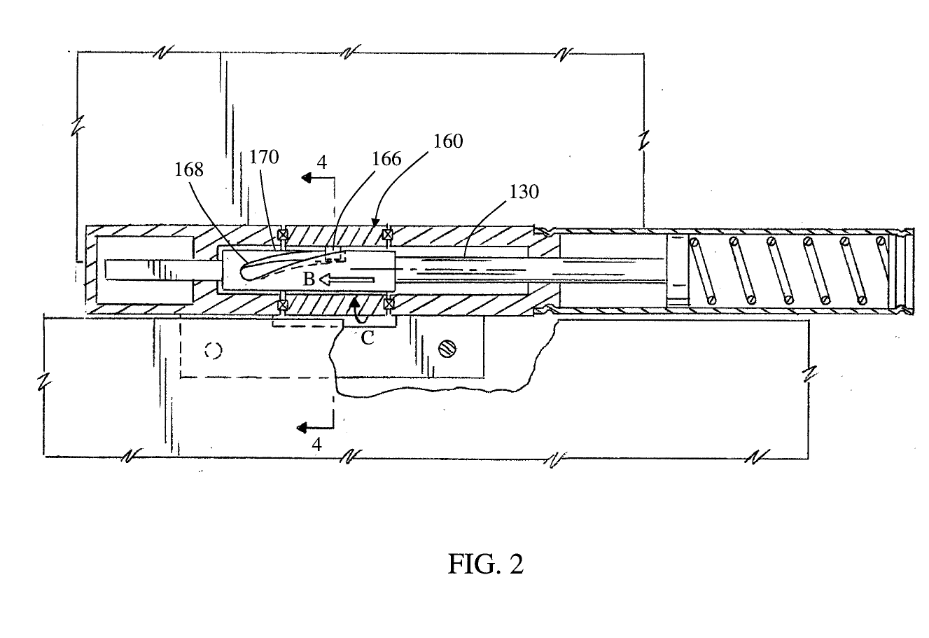

Referring now to FIGS. 1-2, there is illustrated a spring system 100 including a linear motion device 120 and a rotary motion translation device 160. The linear motion device 120 is illustrated as being in the form of a strut. The linear motion device includes a housing body 122 having an internal cavity 124, and a rod 130. The housing body can optionally be secured to stationary structure 40 by a screw, bolt, adhesive, solder, weld bead, or the like. Generally, the housing body is rigidly connected to the stationary structure so as to limit or prevent movement of the housing body relative to the stationary structure; however, this is not required.

The rear end of housing body 122 is illustrated as including a plug 126. The plug can be configured to be removable from the housing body; however, this is not required. Indents 128 in the wall of the housing body 122 are used to facilitate in securing the plug 126 to the housing.

The front end of the housing body 122 is illustrated as including a bushing 136. The bushing is illustrated as including an opening 137 to enable at least a portion of a rod 130 to move through the bushing along the longitudinal axis of the housing body 122. Rod 130 is configured to extend at least partially outwardly from the front end of the housing body. Flange 138 of the housing body 122 is used to facilitate in securing the bushing 136 to the housing; however, this is not required. As can be appreciated, other or alternative structures or means can be used to secure the bushing to the housing.

Rod 130 is illustrated in FIGS. 1-2 as extending outwardly from the housing body 122 through the opening 137 of bushing 136 in the front end of the housing body, and is configured to move along the longitudinal axis of the housing body. Rod 130 is illustrated as including a piston or guide bushing 132 connected to the rear portion of the rod. The piston or guide bushing 132 is typically connected to the rear end of the rod 130; however, this is not required. One or more portions of the rod can optionally include structural members to prevent the rod from rotating within the internal cavity during operation; however, this is not required. The size, shape and configuration of the one or more structural members are non-limiting.

With continued reference to FIGS. 1-2, the spring system is illustrated as including a mechanical spring 140 positioned in the internal cavity 124 of the housing body 122. As can be appreciated, the spring system can include more than one mechanical spring. As can also be appreciated, the spring system can be a gas spring that includes or does not include one or more mechanical springs. Mechanical spring 140 is illustrated as being positioned on the rear side of the piston or guide bushing 132 and is positioned between the piston or guide bushing and the rear end of the housing body. A first end of the mechanical spring 140 can be connected to the rear surface of the piston or guide bushing 132; however, this is not required. A second end of the mechanical spring 140 can be connected to the front surface of rear plug 126; however, this is not required. Thus, the mechanical spring 140 is configured to cause linear movement of the rod along the longitudinal axis of the housing body. In such a configuration, as the rod 130 is moved outwardly from the housing 122 to the fully extended position, mechanical spring 140 is caused to extend in length. As the rod 130 moves toward the fully retracted position, the mechanical spring 140 is caused to be compressed. As illustrated in FIGS. 1-2, the mechanical spring 140 is configured to bias the rod in the fully extended position; however, this is not required.

As illustrated in FIGS. 1-2, bushing 136 extends outwardly from the front end of the housing body. The front portion of the bushing has a cavity 139 having a cross-sectional area that is greater than a cross-sectional area of opening 137; however, it can be appreciated that the cross-sectional area of the cavity can be the same as or less than the cross-sectional area of opening 137. The cross-sectional area of cavity 139 is illustrated as being generally constant along the longitudinal length of the cavity; however, this is not required.

Connected to a front portion of the rod is a rotation member 170. The rotation member is secured to or formed on the rod such that the rotation member does not rotate independently of the rod. When the rotation member is separate component of the rod, the rotation member can be rigidly connected to the rod by an adhesive, weld bead, solder, rivet, screw or the like. The rotation member is configured to move within cavity 139 as the rod moves between the fully extended and fully retracted positions. In one non-limiting configuration, when the rod is in the fully retracted position as illustrated in FIG. 1, about 20-100% (and all values and ranges therebetween) of the longitudinal length of the rotation member is located in the cavity, typically about 20-90% of the longitudinal length of the rotation member is located in the cavity, and more typically about 40%-80% of the longitudinal length of the rotation member is located in the cavity. In another non-limiting configuration, when the rod is in the fully extended position as illustrated in FIG. 2, about 0-70% (and all values and ranges therebetween) of the longitudinal length of the rotation member is located in the cavity, typically about 0.1-50% of the longitudinal length of the rotation member is located in the cavity, and more typically about 1%-10% of the longitudinal length of the rotation member is located in the cavity. As can be appreciated, the rotation member can extend fully outside the cavity when the rod is in the fully extended position.

The rotation member is illustrated as including a slot 172 that extends at least partially along the longitudinal length of the rotation member and also has a twisting shape about the outer surface of the rotation member as illustrated in FIGS. 1-2. The slot can have a twisting shape that is generally 5-360° (and all values and ranges therebetween) about the outer surface of the rotational member. Generally, the slot has a half twist (180° twist) or a one quarter twist (90° twist) about the outer surface of the rotational member; however, the degree of twist can be more than or less than one half or one quarter twist on the rotational member. The length of the slot generally extends about 5-95% (and all values and ranges therebetween) of the longitudinal length of the rotation member, and typically about 30-90% of the longitudinal length of the rotation member. Generally, one or both ends of the slot are spaced inwardly from the end edges of the rotation member; however, this is not required.

As illustrated in FIGS. 1-2, a rotary motion translation device 160 is positioned adjacent to the front end of bushing 136. The front end 141 of bushing 136 and the rear end 161 of rotary motion translation device 160 can optionally include a slot that is configured to receive a portion of a washer or seal 171. The washer or seal can be formed of any number of materials (e.g., metal, rubber, elastomeric material, etc.). Rotary motion translation device 160 is configured to rotate relative to bushing 136. When washer or seal 171 is used, such washer or seal can facilitate in the movement of the rotary motion translation device 160 relative to bushing 136 and/or form a liquid and/or air tight seal between the front end of bushing 136 and the rear end of the rotary motion translation device.

The front end 163 of the rotary motion translation device 160 is positioned adjacent to the rear end 202 of mount block 200. The front end 163 of the rotary motion translation device and the rear end 202 of the mount block can optionally include a slot that is configured to receive a portion of a washer or seal 173. The washer or seal can be formed of any number of materials (e.g., metal, rubber, elastomeric material, etc.). Rotary motion translation device 160 is configured to rotate relative to mount block 200. When washer or seal 173 is used, such washer or seal can facilitate in the movement of the rotary motion translation device 160 relative to mount block 200 and/or form a liquid and/or air tight seal between the front end of the rotary motion translation device and the rear end of the mount block.

In one non-limiting arrangement, the mount block and bushing 136 are secured so as to remain stationary and the rotary motion translation device is configured to rotate relative to the mount block and the bushing. The mount block and/or bushing, similar to housing body 122, can optionally be secured to stationary structure 40 by a screw, bolt, adhesive, solder, weldbead, or the like. Generally, the mount block is rigidly connected to the stationary structure so as to limit or prevent movement of the mount block relative to the stationary structure; however, this is not required.

The rear portion of the mount block is illustrated as including a rear cavity 204 and the front portion of the mount block includes a front cavity 208. An opening 206 is positioned between the front and rear cavities. The front portion 131 of the rod is illustrated as extending forwardly from rotation member 170 and extending into rear cavity 204 and through opening 206 and into front cavity 208. The cross-sectional area of opening 206 is illustrated as being smaller than the cross-section area of the front and rear cavities; however, this is not required. The cross-sectional area of the front cavity is illustrated as being larger than the cross-sectional area of the rear cavity; however, this is not required.

The front portion 131 of rod 130 has a non-circular cross-sectional shape. One non-limiting cross-sectional shape is a square-shape; however, it can be appreciated that other non-circular shapes can be used (e.g., triangular, rectangular, oval, polygonal, etc.). The cross-sectional shape of opening 206 is selected to have the same or substantially the same cross-sectional shape of the non-circular front portion of the rod. The use of non-circular cross-sectional shapes for the opening and the front portion of the rod enables the front portion of the rod to move longitudinally in opening 206 as the rod moves between the fully extended and fully retracted positions while also inhibiting or preventing the rod from rotating about the longitudinal axis of the rod. As can be appreciated; other arrangements can be used to enable the front portion of the rod to move longitudinally in opening 206 as the rod moves between the fully extended and fully retracted positions while also inhibiting or preventing the rod from rotating about the longitudinal axis of the rod. For example, the front portion of the rod could have a generally circular cross-sectional shape and also have a groove or rib on the outer surface of the front portion of the rod that interacts with a structure in opening 206 that allows the rod to move between the fully extended and fully retracted positions while also inhibiting or preventing the rod from rotating about the longitudinal axis of the rod. As also can be appreciated, a similar arrangement as discussed above with regard to the front portion of the rod and opening 206 could also or alternatively be used for the portion of the rod that move through opening 137 of the bushing 136 so as to allow the rod to move between the fully extended and fully retracted positions while also inhibiting or preventing the rod from rotating about the longitudinal axis of the rod.

As illustrated in FIGS. 1-2, the cross-sectional shape and cross-sectional size of cavity 139 of bushing 136, cavity 167 of rotary motion translation device 160, and rear cavity 204 of mount block 200 are the same; however, this is not required. The cross-sectional shape and cross-sectional size of cavity 139 of bushing 136, cavity 167 of rotary motion translation device 160, and rear cavity 204 of mount block 200 are shaped and sized to allow the rotation member 170 to move in such cavities as the rod moves between the fully retracted and fully extended positions.

As illustrated in FIGS. 1-2, the rotation member 170 is sized and configured to move into rear cavity 204 of the mount block when the rod moves to a fully extended position. As illustrated in FIG. 2, about 5-80% (and all values and ranges therebetween) of the longitudinal length of the rotation member 170 is positioned in the rear cavity 204 of the mount block when the rod moves to a fully extended position, typically about 10-60% of the longitudinal length of the rotation member 170 is positioned in the rear cavity 204 of the mount block when the rod moves to a fully extended position, and more typically about 10% to less than 50%, of the longitudinal length of the rotation member 170 is positioned in the rear cavity 204 of the mount block when the rod moves to a fully extended position.

Generally, at least a portion of the rotation member 170 is always present in cavity 167 of rotary motion translation device 160 as the rod moves between the fully extended and fully retracted position; however, this is not required.

As also illustrated in FIGS. 1-2, the end of rod 130 extends into front cavity 208 of the mount block when the rod moves to the fully extended position. The end of the rod can be configured to remain in the front cavity when in the fully retracted position; however, this is not required. Generally, the end of the rod remains within opening 206 when the rod is in the fully retracted position.

As illustrated in FIGS. 1-4, the rotary motion translation device 160 is integrated in at least a portion of a hinge assembly. As illustrated in FIGS. 1-4, the hinge assembly includes a first hinge plate 50 that is connected to a door frame, container base or some other stationary structure 40 by a screw, bolt, or the like 52. As can be appreciated, the hinge assembly can be any type of hinge assembly (e.g., butt hinge, T-hinge, strap hinge, Soss hinge, cabinet hinges, gate hinge, bi-fold hinge, case hinges, continuous hinge, etc.).

The housing body 122 of the linear motion device 120 and/or the mount block can be optionally connected to the first hinge plate 50. In such an optional arrangement, the connecting of the first hinge plate to the door frame, container base or some other stationary structure 40 also results in the housing body and/or mount block being rigidly connected to the door frame, container base or some other stationary structure 40. As can also be appreciated, a spring housing can be used to house the linear motion device 120 and/or the mount block and such spring housing can be independently connected to the door frame, container base, or some other stationary structure 40 and/or be connected to the first hinge plate.

The first hinge plate is rotatably connected to rotary motion translation device 160 such that the rotary motion translation device 160 can rotate relative to the first hinge plate. The hinge assembly also includes a second hinge plate 70 that is rigidly connected to the rotary motion translation device. The second hinge plate is connected to a door or cover or some other movable structure 60 is configured to move relative to the door frame, container base or some other stationary structure 40. The second hinge plate is connected to a door or cover or some other movable structure 60 by a screw, bolt, or the like 72.

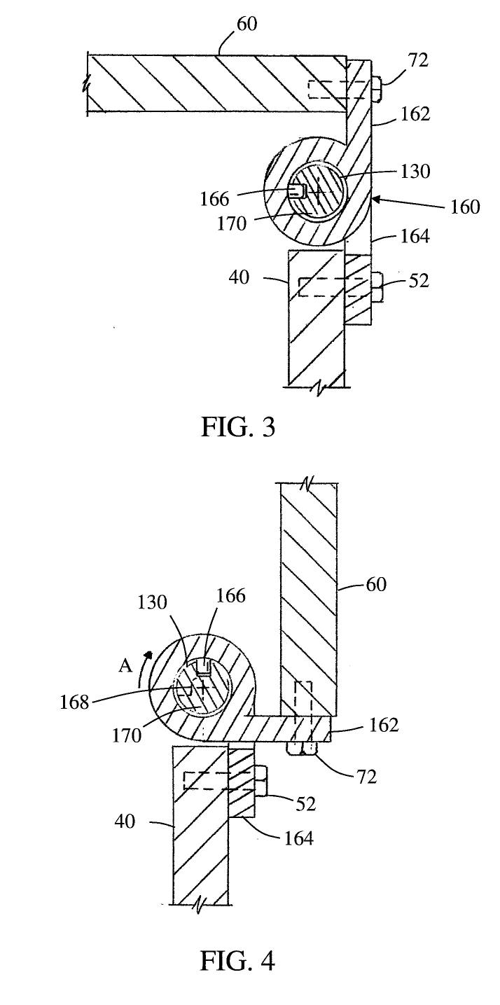

As illustrated in FIGS. 3-4, rotary motion translation device 160 includes a pin 166 that is configured to move in and along slot 172 of rotation member 170. As illustrated in FIGS. 1 and 3, the hinge assembly is illustrated in the closed position. The rod 130 is illustrated as being in a retracted position when the hinge assembly is in the closed position. Pin 166 is illustrated as being positioned at or near the front end slot 172. As the rod 130 moves toward the fully extended position, the rotation member 170 is caused to move forwardly in cavity 139 of bushing 136, and cavity 167 of rotary motion translation device 160, and into rear cavity 204 of mount block 200. Such movement of the rotation member 170 causes the pin to move in and along slot 170 to the rear end of the rotation member 170. The twisted shape of the slot causes the pin to move partially about the longitudinal axis of the rod as the pin moves along and within slot 172. As illustrated FIGS. 2 and 4, when the rod moves to an extended position as indicated by arrow B, the rotation member 170 causes the rotary motion translation device 160 to rotate about the longitudinal axis of the rod as indicated by arrow A, thereby causing the hinge assembly to move to an open position. Such an arrangement results in the linear motion of the rod being translated into a rotational movement by the rotary motion translation device 160 to cause the hinge assembly to move between the open and closed positions.

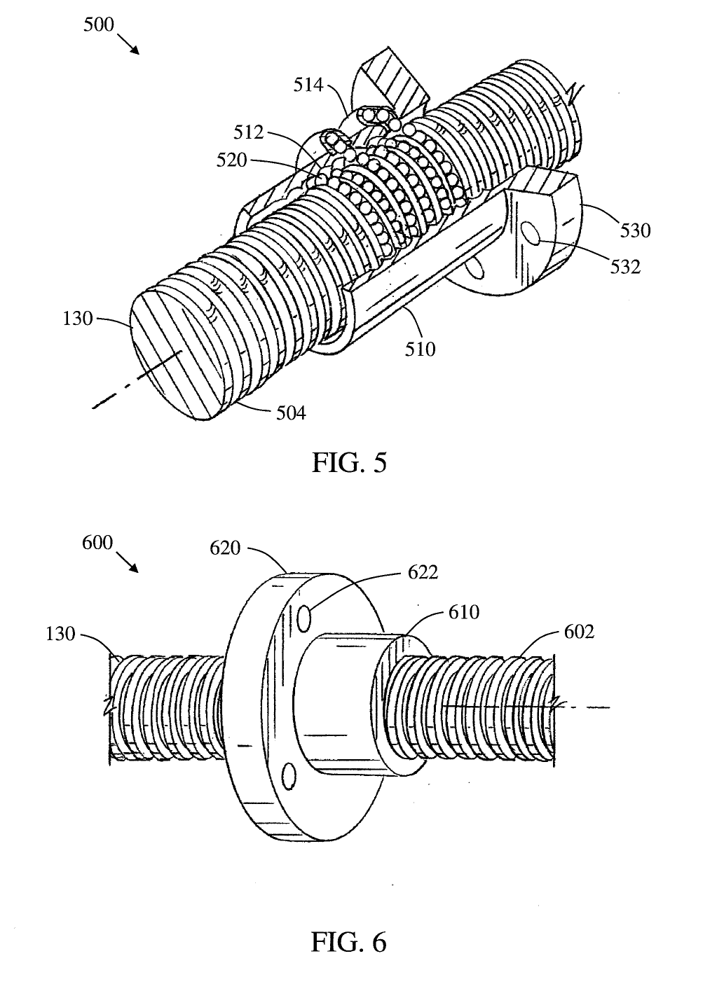

FIGS. 5-7 illustrate additional non-limiting rotary motion translation devices suitable for use with the spring system of the present invention. Although FIGS. 5-7 illustrate a ball screw, acme threaded rod, and ball reverser, respectively, it can be appreciated that other or additional linear to rotary motion translation devices can be used. The rotary motion translation devices as illustrated in FIGS. 5-7 can be used in conjunction with the spring system as illustrated in FIGS. 1-4 by merely modifying a portion of rod 130, and removing rotation member 170.

Referring now to FIG. 5, there is illustrated a ball screw 500 capable of translating linear movement of a rod 502 into rotary motion. As illustrated in FIG. 5, ball screw 500 comprises a flange 530 having a plurality of holes and/or apertures 532 and a hollow ball screw nut 510. The plurality of holes and/or apertures are suitable for releas ably securing the ball screw 500 to any object (e.g., a portion of a hinge assembly, etc.). Ball screw 500 is illustrated as also including a plurality of balls 520. The plurality of balls are positionable between the ball screw nut 510 and the rod 130.

The outer surface of the rod 130 is illustrated as being grooved. As illustrated in FIG. 5, the grooved structure of rod 130 defines a ball rolling groove 504 continuous along the peripheral surface of the rod in a generally spiral structure. Similarly, the inner surface of the ball screw nut 510 is illustrated as being grooved. The grooved inner surface of the ball screw nut 510 defines a ball rolling groove 512 continuous along the inner surface of the ball screw nut in a generally spiral structure. The spiral structure of ball rolling groove 512 is designed to correspond with the spiral structure of ball rolling groove 504, thereby allowing balls 520 to roll therebetween.

In operation, when the rod 130 is moved between the fully extended and fully retracted positions, the balls 520 roll between groove 504 of rod 130 and groove 512 of ball screw nut 510. The ball 520 arriving at one end of groove 512 returns to another end of the groove 504 via a return tube 514 connected to the ball screw nut 510. This arrangement causes the ball screw nut to rotate about the longitudinal axis of the rod as the rod moves between the fully extended and fully retracted positions, thus resulting in the hinge assembly moving between the open and closed positions.

Referring now to FIG. 6, there is illustrated a rotary motion translation device 600 capable of translating linear motion of a rod 130 into rotation. As illustrated in FIG. 6, the rotary motion translation device 600 comprises a flange 620 having a plurality of holes and/or apertures 622 and a hollow screw nut 610. The plurality of holes and/or apertures are suitable for releasably securing the rotary motion translation device 600 to any object (e.g., a portion of a hinge assembly, etc.).

The outer surface of the rod 130 is illustrated as being threaded. The size, shape and orientation of the threaded rod are non-limiting. As illustrated in FIG. 6, the threaded outer surface of the rod 130 is continuous along the peripheral surface of the rod in a generally spiral structure, at least in the region where the rod interacts with the rotary motion translation device. Similarly, the inner surface of the screw nut 610 includes a thread (not shown). Generally, the thread of the screw nut 610 corresponds in shape and size to the threading on rod 130; however, this is not required.

In operation, when the rod 130 is moved between the fully extended and fully retracted positions, the rotary motion translation device 600 rotates about the longitudinal axis of the rod, thus resulting the hinge assembly moving between the open and closed positions.

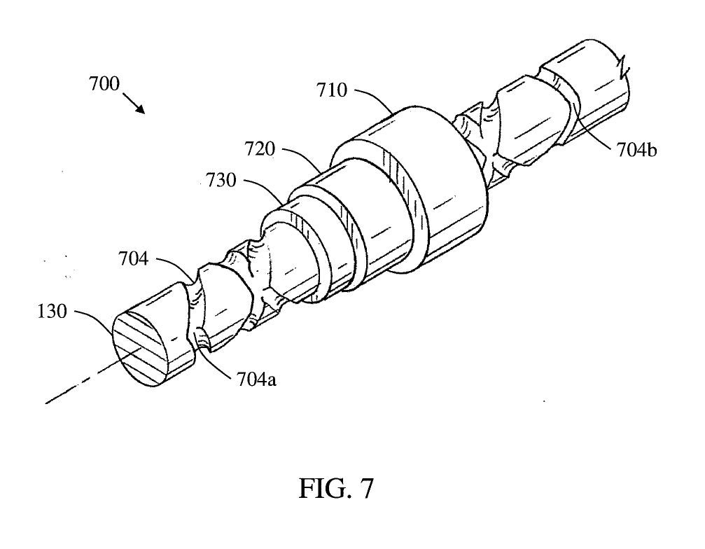

Referring now to FIG. 7, there is illustrated a ball reverser actuator 700 capable of translating linear motion into rotation. As illustrated in FIG. 7, the ball reverser actuator 700 includes a flange 710, a first housing portion 720, and a second housing portion 730. A plurality of fixed and/or slot balls (not shown) can be included in the first and second housing portions 720, 730, said fixed and/or slot balls typically designed to interact with one or more grooves on the outer surface of rod 130.

The outer surface of the rod 130 is illustrated as including a continuous groove 704 about its peripheral surface at least in the region on the rod where the rod interacts with the rotary motion translation device 700. The groove 704 is illustrated as comprising a general spiral shape in a first direction along the longitudinal axis of the rod 130, and an overlapping general spiral shape in a second direction along the longitudinal axis of the rod 130. At each end of the groove 704, turnarounds 704a, 704b are provided to reverse the direction of movement of the ball reverser actuator 700.

In operation, when the rod 130 is moved between the fully extended and fully retracted positions, the rotary motion translation device 700 rotates about the longitudinal axis of the rod, thus resulting in the hinge assembly moving between the open and closed positions.

The embodiments of the spring system illustrated in FIGS. 1-7 can be used to function as a counterbalance for a lid to a container, a hood to a vehicle, and the like. For example, when the spring system is used to facilitate in the opening and closing of a lid to a container, the mechanical spring 140 can be selected to balance the weight of the movable cover on the container. When the cover is in the closed position, the mechanical spring 140 is in the partial or fully compressed position. In such a position, the spring exerts a force on the rod to move to the extended position. As such, when the cover is moved from the closed to the open position, the force exerted on the rod helps to move the cover to the open position (i.e., counterbalances the weight of the cover). When the cover is moved to the closed position, the mechanical spring 140 is caused to be compressed, thus resisting the closing of the cover.

As can be appreciated, the spring system can be designed to control the movement of the rod (e.g., a hydraulic piston, electromagnetic spring system, a system connected to a gas source, etc.) to move to an extended position and back to a retracted position, thus controllably causing the hinge to both open and close.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawing shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

What is claimed:

1. A spring system comprising:
a linear motion device to provide linear motion, said linear motion device including a rod, said linear motion device configured to cause said rod to move between a fully extended position and a fully retracted position;
a rotary motion translation device configured to translate said linear motion into a rotational motion, said rotary motion translation device configured to receive at least a portion of said rod as said rod moves between said fully extended position and said fully retracted position, at least a portion of said rotary motion translation device configured to rotated at least partially about a longitudinal axis of said rod as said rod moves between said fully extended position and said fully retracted position; and,
a hinge assembly having first and second plates and a hinge line between said first and second plates, said second plate connected to at least a portion of said rotary motion translation device,
wherein said spring system translates linear motion into rotary motion at, near, or on said hinge line of said hinge assembly when said rod moves between said fully extended position and said fully retracted position.

2. The spring system of claim 1, wherein said linear motion device is selected from the group consisting of a gas spring, mechanical struts, urethane spring, hydraulic piston, electromagnetic spring, or combination thereof.

3. The spring system as defined in claim 1, including a rotation limit arrangement configured to inhibit or prevent said rod from rotating 360° about a longitudinal axis of said rod as said rod moves between said fully extended position and said fully retracted position.

4. The spring system as defined in claim 3, wherein said rotation limit arrangement includes a mount block having a non-circular cross-sectional shaped block opening that is configured to receive a portion of said rod as said rod moves between said fully extended position and said fully retracted position, a portion of said rod that is configured to move into said block opening of said mount block has a same or similar cross-sectional shape as said non-circular cross-sectional shape of said block opening.

5. The spring system as defined in claim 1, including a bushing connected to a front end of a housing body of said linear motion device, said bushing having a bushing opening configured to enable a portion of said rod to pass through said bushing opening as said rod moves between said fully extended position and said fully retracted position, a rear end of said rotary motion translation device is positioned adjacent to said bushing, at least a portion of said rotary motion translation device movable relative to said bushing as said rod moves between said fully extended position and said fully retracted position.

6. The spring system as defined in claim 5, wherein a front end of said rotary motion translation device is positioned adjacent to a mount block, at least a portion of said rotary motion translation device movable relative to said mount block as said rod moves between said fully extended position and said fully retracted position, said mount block configured to receive at least a portion of said rod as said rod moves between said fully extended position and said fully retracted position.

7. The spring system as defined in claim 5, wherein a washer or seal is positioned in a groove located between said rotary motion translation device and said mount block, said rotary motion translation device and said bushing, or combinations thereof.

8. The spring system as defined claim 1, wherein said rod includes a rotation member that is configured to interact with said rotary motion translation device to cause at least a portion of said rotary motion translation device to rotate at least partially about a longitudinal axis of said rod as said rod moves between said fully extended position and said fully retracted position.

9. The spring system as defined in claim 8, wherein said rotary motion translation device includes a translation device cavity that is sized and shaped to enable said rotation member to move within said translation device cavity as said rod moves between said fully extended position and said fully retracted position.

10. The spring system as defined in claim 9, wherein a bushing connected a front end of a housing body of said linear motion device includes a bushing cavity in a front portion of said bushing, said bushing cavity sized and shaped to enable said rotation member to move within said bushing cavity as said rod moves between said fully extended position and said fully retracted position.

11. The spring system as defined in claim 9, wherein a mount block positioned adjacent to said rotary motion translation device includes a mount cavity in a rear portion of said mount block, said mount cavity sized and shaped to enable said rotation member to move within said mount cavity as said rod moves between said fully extended position and said fully retracted position.

12. The spring system as defined in claim 8, wherein a) said rotation member includes a slot positioned along at least a portion of a longitudinal length of said rotation member and which said slot twists about at least a portion of a circumference of said rotation member, and said rotary motion translation device includes a pin that at least partially extends into said slot of said rotation member and which said pin is configured to move along a longitudinal length of said slot as said rod moves between said fully extended position and said fully retracted position, or b) said rotary motion translation device includes a slot positioned along said translation device cavity at least a portion of a longitudinal length of said translation device cavity and which said slot twists about at least a portion of a circumference of said translation device cavity, and said rotation member includes a pin that at least partially extends into said slot of said rotary motion translation and which said pin is configured to move along a longitudinal length of said slot as said rod moves between said fully extended position and said fully retracted position.

13. A device used to facilitate in moving a movable structure relative to a base structure comprising:
a linear motion device to provide linear motion, said linear motion device including a rod, said linear motion device configured to cause said rod to move between a fully extended position and a fully retracted position;
a rotary motion translation device configured to translate said linear motion into a rotational motion, said rotary motion translation device configured to receive at least a portion of said rod as said rod moves between said fully extended position and said fully retracted position, at least a portion of said rotary motion translation device configured to rotate at least partially about a longitudinal axis of said rod as said rod moves between said fully extended position and said fully retracted position; and,
a hinge assembly having first and second plates and a hinge line between said first and second plates, said second plate connected to at least a portion of said rotary motion translation device, said first plate connected or interconnected to said base structure, said second plate connected or interconnected to said movable structure
wherein said spring system translates linear motion into rotary motion at, near, or on said hinge line of said hinge assembly when said rod moves between said fully extended position and said fully retracted position to thereby cause said movable structure to move relative to said base structure.

14. The device as defined in claim 13, wherein said base structure is selected from the group consisting of a door frame, a vehicle, a container, a cabinet, a window frame, said movable structure selected from the group consisting of a door, a hood, a hatch, a lid, and a window.

15. A method for facilitating in moving a movable structure relative to a base structure comprising:
a. providing a spring system, said spring system including
a linear motion device to provide linear motion, said linear motion device including a rod, said linear motion device configured to cause said rod to move between a fully extended position and a fully retracted position;
a rotary motion translation device configured to translate said linear motion into a rotational motion, said rotary motion translation device configured to receive at least a portion of said rod as said rod moves between said fully extended position and said fully retracted position, at least a portion of said rotary motion translation device configured to rotate at least partially about a longitudinal axis of said rod as said rod moves between said fully extended position and said fully retracted position;
b. providing a hinge assembly having first and second plates and a hinge line between said first and second plates, said second plate connected to at least a portion of said rotary motion translation device, said first plate connected or interconnected to said base structure, said second plate connected or interconnected to said movable structure; and,
c. moving said movable structure between an open position and closed position to thereby cause said rod to move and said rotary motion translation device to rotate at least partially about a longitudinal axis of said rod.

16. The method as defined in claim 15, wherein said spring system at least partially functions as a counterbalance to said movable structure.
